(19) United States
(12) Patent Application Publication
(10) Pub. No.: US 2006/0072398 A1
(43) Pub. Date: Apr. 6, 2006

(54) Data transmission control method

(76) Inventor: Akiyoshi Yamashita, Matsuyama-shi (JP)

Correspondence Address: STEPTOE & JOHNSON LLP, 1330 CONNECTICUT AVENUE, N.W., WASHINGTON, DC, 20036, US

(21) Appl. No.: 10/546,726

(22) PCT Filed: Mar. 8, 2004
(86) PCT No.: PCT/JP04/02984

§ 371 Date: Aug. 24, 2005

(30) Foreign Application Priority Data
Mar. 10, 2003 (JP) 2003-062597

(51) Int. Cl. G11B 19/02; G11B 5/09

(52) U.S. Cl. 369/47.1; 369/59.1

(57) ABSTRACT

A transfer control method is provided to enable efficient data transfer when a single optical disk device (2) is accessed by a plurality of host computers (3). The method includes: an access position obtaining step of interpreting instructions issued from a plurality of tasks provided on the plurality of host computers (3) to the optical disk device (2) and obtaining the access position of data on an optical disk (1); an access ordering step of generating an access order table for data to be read in sequence, based on the access position obtained at the access position obtaining step; a data storing step of reading the data sequentially according to the access order table generated at the access ordering step and storing the data in a data buffer; and a data transfer step of transferring the data stored in the data buffer to the host computers (3) in an operation period before the optical disk device (2) becomes ready to transfer the next data.

### TECHNICAL FIELD

The present invention generally relates to digital computers/electrical digital processing devices and in particular to a data transfer control method for optical disk devices or tape devices.

### BACKGROUND ART

FIG. 7 shows how two host computers access an optical disk device through an interface such as a network.

Each of the two host computers (hereinafter referred to as host A and host B) 51 (51A, 51B) requests stream data in FIG. 7. Reference numeral 52 denotes an optical disk device (hereinafter referred to as the device), which locates requested stream data on an optical disk (hereinafter referred to as a recording medium) 54 and transfers data to the host computes 51 through an interface (such as a network and an interface for connecting peripheral devices) 53.

Reference mark ds0 denotes stream data on the recording medium 54 requested by host A, ds1 denotes stream data 1 requested by host B, ds0-sp and ds0-ep denote the positions of the start and end sectors of the stream data ds0, respectively, ds1-sp and ds1-ep denote the positions of the start and end sectors of the stream data ds1, respectively, ts01 denotes the seek time from stream data ds0 to stream data ds1, ts10 denotes the seek time from stream data ds1 to stream data ds0, tr10 denotes the rotational delay time required to reach the next position in the sector of stream data ds0 after stream data ds1 is processed, and drd denotes the direction of rotation of the recording medium.

When the two hosts, host A (51A) and host B (51B), at the same time try to read different pieces of stream data from the single device 52 in this configuration, they go through the following steps.

Host A (51A) issues a command to the device 52 through the interface 53, host B (51B) issues a command to the device 52 through the interface 53, the device 52 transfers the data to host A (51A) through the interface 53, and the device 52 transfers the data to host B (51B) through the interface 53. Thus, the stream data is transferred (see Japanese Patent Laid-Open No. 2001-195808, No. 2000-165844, and No. 10-507542).

### DISCLOSURE OF THE INVENTION

According to the prior-art data transfer method, when a number of tasks provided on each of a number of hosts or on a single host try to access the same device at the same time, data will be transferred from two or more different locations on the same recording medium.

In that case, the seeks and rotational delay time to access the different sector positions are wasted in a device and thus time required for transferring data to the hosts increases. As the number of hosts or tasks increases, so does the number of types of access and therefore the time required for data transfer. A delay in data transfer to each host is caused, which results in unsmooth reproduction of data and breaks in videos and audios.

If the device is a tape device, time is wasted in rewind/fast-forward operations for accessing different data positions and read operations in index areas. Thus, as in an optical disk device, the time required for data transfer increases.

Therefore, an object of the present invention is to provide a data transfer control method capable of preventing increases in time required for data transfer due to seeks and rotational delays which occur in different areas when a number of tasks on one or more hosts access different areas on a recording medium in a device.

In order to solve the problem, there is provided according to claim 1 of the present invention a data transfer control method for controlling transfer of data from a recording medium in an information recording device to a data processing device having at least a data reproduction function, comprising: an access position obtaining step of interpreting instructions issued from a plurality of tasks provided on one or more data processing devices to the information recording device and obtaining access positions of data on the recording medium; an access ordering step of, based on the access positions obtained at the access position obtaining step, generating an access order table for data to be read in sequence; a data storing step of reading the data sequentially in accordance with the access order table generated at the access ordering step and storing the data in a data buffer; and a data transfer step of transferring the data stored in the data buffer to the one or more data processing devices in an operation period before the information recording device becomes ready to transfer the next data.

In a data transfer control method according to claim 2, when the information recording device is accessed in response to the instructions from the tasks in the data transfer control method according to claim 1, firmware provided in the information recording device provides control.

In a data transfer control method according to claim 3, when the information recording device is accessed in response to the instructions from the tasks in the data transfer control method in claim 1, driving software of the information recording device provided in the one or more data processing devices provides control.

In a data transfer control method according to claim 4, the amount of data to be stored in the data buffer in the data transfer control method according to any of claims 1 to 3 is determined such that the time required for transferring the data exceeds the total time required for reading by the other tasks than the task to which the data is to be transferred.

In a data transfer control method according to claim 5, a plurality of data processing devices are connected with a plurality of information recording devices through connection switching equipment and the transfer control method according to any of claims 1 to 4 is performed.

According to the transfer control methods described above, an access order table is generated that indicates the access positions of sequential data on a recording medium in response to access requests from a plurality of tasks on a data processing device or devices, a number of blocks of data to be transferred are stored in a data buffer according to the access order table, and the data is transferred in a batch from the data buffer to the data processing device during a period in which the information recording device is preparing for reading other data. Thus, wastful time in the information recording device can be avoided and efficient data transfer can be performed. That is, delays in data transfer can be reduced and therefore, if the data processing device is a video player, video can be played back (delivered) without breaks.

### BRIEF DESCRIPTION OF THE DRAWINGS

FIG. 1 is a schematic diagram showing a general configuration of a device and illustrating a data transfer control method according to a first embodiment of the present invention;

FIG. 2 is a graph showing the relationship in number between connected hosts and read blocks according to the data transfer control method when the data transfer rate of a device is 900 KB/second;

FIG. 3 is a graph showing the relationship in number between connected hosts and read blocks according to the data transfer control method when the data transfer rate of a device is 1,800 KB/second;

FIG. 4 is a graph showing the relationship in number between connected hosts and read blocks according to the data transfer control method when the data transfer rate of a device is 7,200 KB/second;

FIG. 5 is a schematic diagram showing a general configuration of a device and illustrating a data transfer control method according to a second embodiment of the present invention;

FIG. 6 is a schematic diagram showing a general configuration of a device and illustrating a data transfer control method according to a third embodiment of the present invention; and

FIG. 7 is a schematic diagram showing a general configuration of a device and illustrating a data transfer control method according to a prior art example.

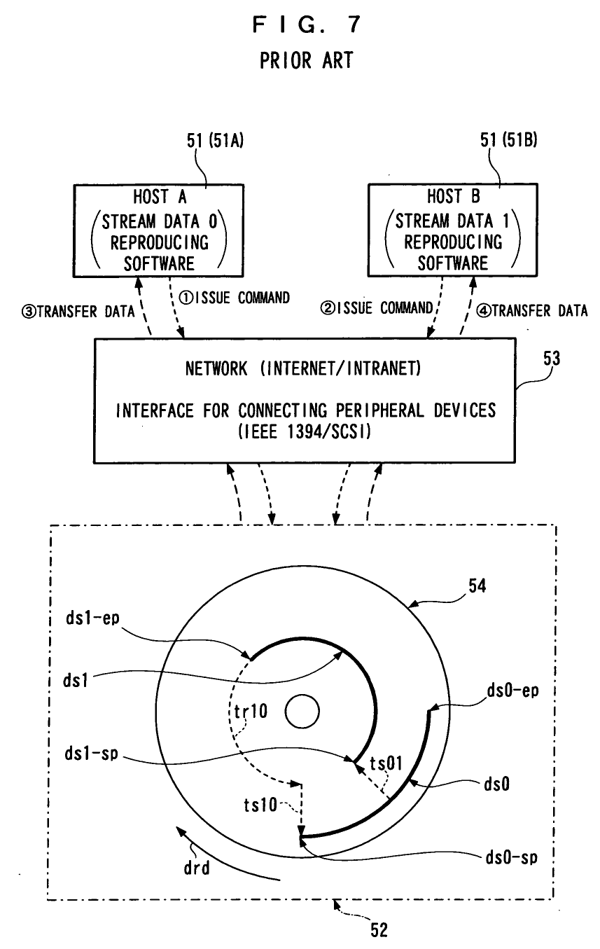

### BEST MODE FOR CARRYING OUT THE INVENTION

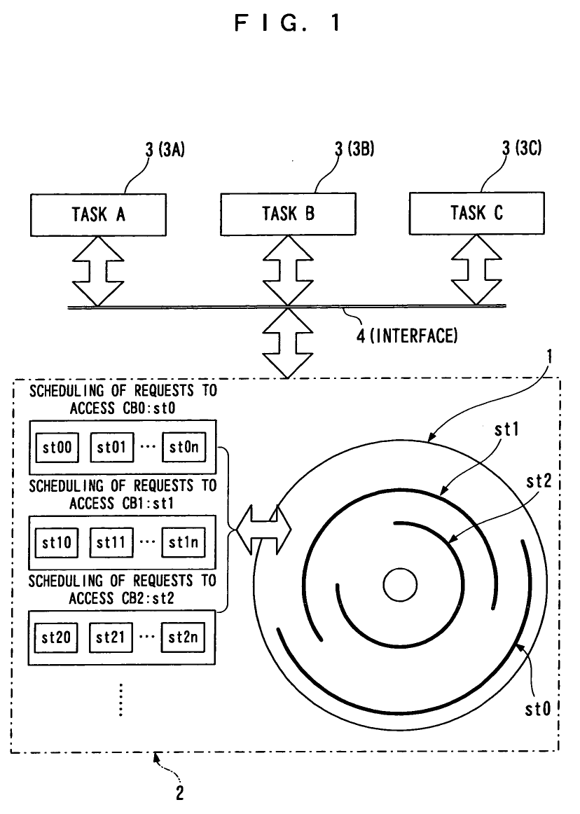

A data transfer control method according to a first embodiment of the present invention will be described below with reference to FIG. 1.

Before describing the data transfer control method, the device environment to which the transfer control method is applied will be described first.

The data transfer control method is described with respect to an example in which a number of host computers, for example three host computers (exemplary data processing devices having at least a reproduction mechanism, which may be in particular video players, hereinafter referred to as host A, host B, and host C) 3 (3A-3C) access a single optical disk device (an example of an information recording device, which may be a tape device, hereinafter referred to the device) 2 including an optical disk (hereinafter referred to as the recording medium) 1 on which a large amount of stream data (hereinafter sometimes simply referred to as data) such as video data is recorded, through an interface (such as IEEE 1394 or SCSI interface for connecting peripheral devices) 4 to read stream data 0 to 2 (st0-st2), respectively, as shown in FIG. 1.

Provided in firmware in the device 2 are, as a schedule managing section, a section for scheduling requests to access stream data 0 (st0) (st00, st01, . . . , st0n: st0 access request block) CB0, a section for scheduling requests to access stream data 1 (st10, st10, . . . , st1n: st1 access request block) CB1, and a section for scheduling requests to access stream data 2 (st20, st21, . . . , st2n: st2 access request block) CB2.

It is assumed that host A (3A) issues a request to access stream data 0 (st0) in accordance with task A, host B (3B) issues a request to access stream data 1 (st1) in accordance with task B, and host C (3C) issues a request to access stream data 2 (st2) in accordance with task C.

The data transfer control method will be described below.

The transfer control method is implemented by the firmware in the device 2. Briefly, the method includes an access position obtaining step of interpreting instructions (read or write) issued to the device 2 from tasks (exemplary operation units treated as concepts such as threads and jobs; it is assumed here that there are three tasks A-C) provided on hosts A, B, and C, respectively, and obtaining for each host 3 the positions of sectors (the minimum data-storing-unit blocks), namely access positions on a recording medium 2 to which the hosts 3 attempt to access with its instruction; an access ordering step of organizing access positions obtained at the access position obtaining step in the order of stream data (the order in which the data are arranged on the recording medium) to generate an access order table (also called the schedule table, stored in a schedule buffer, for example, provided in the device) of the stream data read sequentially; a data storing step of pre-storing the stream data read sequentially from the recording medium 1 according to the access order table generated at the access ordering step in a data buffer (which is provided in the interface 4, for example, or may be provided in the device 2, of course); and a data transfer step of transferring the stream data stored at the data storing step to the requesting host 3 in a batch during a read preparation period of time required for the device 2 to become ready to transfer the next data after reading the previous data (in particular, the time required for a seek and rotational delay, also called travel time or, if the information recording device is a tape device, tape rewind time, fast-forward time, index read time, or the like).

The transfer control method generates the access order table indicating the access positions of contiguous data on the recording medium 1 when tasks on the plurality of hosts 3 access (read) their stream data. The method also stores a number of blocks of stream data to be transferred to the data buffer beforehand according to the access order table and transfers the stream data from the data buffer to the requesting host in a batch during a period of time taken in preparing for reading stream data requested by another host (task) in the device 2. Thus, stream data can be read continuously.

The data transfer control method will be described below in detail.

Access requests from hosts 3 to the device 2 are collected in the firmware on the device 2 and the access positions (access targets) are ordered so as to be arranged in sequence to generate an access order table for each host 3, and the access order table is stored in the schedule buffer.

Then, stream data, arranged in sequence according to the access order table, is transferred to the data buffer.

In response to a request from the host 3, stream data is transferred from the data buffer to the host 3 in a batch.

The amount of data stored in the data buffer is such that the time required for transferring the data to the requesting host 3 becomes longer than the total time required for reading operations by the other hosts 3.

Transferring such an amount of stream data to the host 3 avoids idle time (non-data-transfer time) in which no data is transferred until a read of stream data by the next task is performed (to be accurate, until the time at which the stream data is transferred). Thus, the host 3 can reproduce (deliver) data such as video without break.

The amount of data stored in the data buffer will be described in detail below.

This is described with respect to a process in which n hosts 3 attempt to access different sectors on a recording medium 1 in the optical disk device 2 and data transfer for the first host 3 is suspended, another host 3 is served, and then the first host 3 is served again. In the following description, the hosts are labeled with reference symbols (PC1, PC2, . . . , PCn) to distinguish among them.

(1) Move (Seek) from a sector pertinent to host PC1 to a sector pertinent to host PC2.

(2) Wait for the starting position of data pertinent to host PC2 (rotational delay).

(3) Read data pertinent to host PC2 (data transfer).

(4) Seek from the sector pertinent to host PC2 to a sector pertinent to host PC3.

(5) Repeat the process until a sector pertinent to host PCn is reached.

(6) Return (Seek) to the sector pertinent to host PC1, wait for the starting position of the subsequent data (rotational delay), and then transfer the data.

The amount of data stored in this case should be such that the time taken for processing the stream data on the host 3 to which the stream data is transferred, that is, the data transfer time T0, becomes longer than the total time T1 of the seek time and rotational delay time spent for n hosts 3 plus the total time T2 taken for the data transfer for the remaining hosts 3.

This relationship can be expressed by the following expressions:
T0>T1+T2 (1)
T1=2×n×(ts+tr)(seconds) (2)
T2={(n−1)×RB×x}/RD(seconds) (3)

Letting the number of blocks read by a host from the device with one access instruction be x and the amount of block data read by the host from the device at one time be RB (K bytes), the time T0 required for the data transfer for the host can be expressed by equation (4):
T0={(RB×x)/VS}(seconds) (4)

Rewriting expression (1) by substituting expressions (2), (3), and (4) into expression (1) yields the number x of blocks to be stored, by using expression (5) described below:
x>{2×n×(ts+tr)}/{(RB/VS)−(RB×n/RD)+(RB/RD)} (5)

Here, the symbols in the expressions denote the following parameters.

RD: Average data transfer rate (K bytes/second) in the device

ts: Average seek time (seconds) in the device

tr: Average rotational delay time (seconds) in the device

VS: Stream data transfer rate (K bytes/second)

If the device is an optical disk device, the number of data blocks to be read beforehand is calculated from the average seek time of the optical disk device, average rotational delay time, and maximum possible data transfer rate of the optical disk device, and the average data transfer rate, which depends on the type of stream data, and the number of hosts or tasks accessing the device. This number of data blocks are read beforehand by each host or task.

If the device is a tape device, the number of data blocks to be read beforehand is calculated from the average rewind time of the tape device, average fast-forward time, index area read time, maximum possible data transfer rate of the tape device, the average data transfer rate, which depends on the type of stream data, and the number of hosts or tasks accessing the device. This number of data blocks are read beforehand by each host or task.

Instead of reading stream data directly from the recording medium 2 as requested by each host (task A-C) 3, a number of blocks of stream data are stored in the data buffer beforehand such that the time taken for data transfer of the host is longer than the read preparation time (seek time plus rotational delay time) between an access request and the start of the data transfer and, when stream data read operation is performed by the next host, the stored stream data is transferred (read) in a batch to the former. Thus, data transfer is also performed in overhead time such as seek time and rotational delay time. In other words, delays in stream data transfer is eliminated because apparent idle time is avoided. That is, efficient data transfer can be performed. Consequently, data such as video and audio can be reproduced without breaks.

While the amount of data to be stored in the data buffer is calculated after determining the number n of hosts 3 connected to the device 2 in the embodiment described above, the maximum number of hosts 3 that can be connected to the device 2 can be calculated from the maximum amount of data that can be stored in the data buffer by using expression (5).

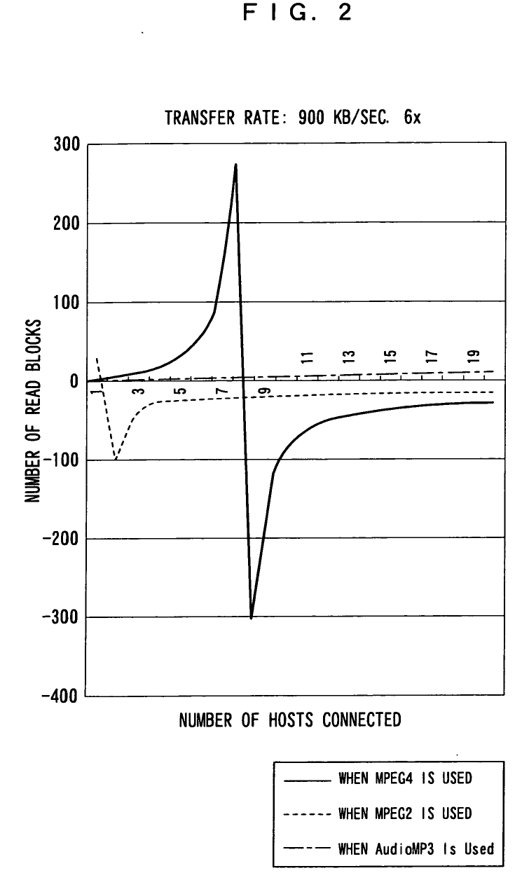

FIGS. 2 to 4 are graphs showing the relationship between the number of blocks of data of three types (MPEG4 image data (120 KB/second), MPEG2 image data (1,350 KB/second), and MPEG3Audio (MP3) image data (16 KB/second)) read in a batch and the number of hosts connected to the device, in terms of different data transfer rates.

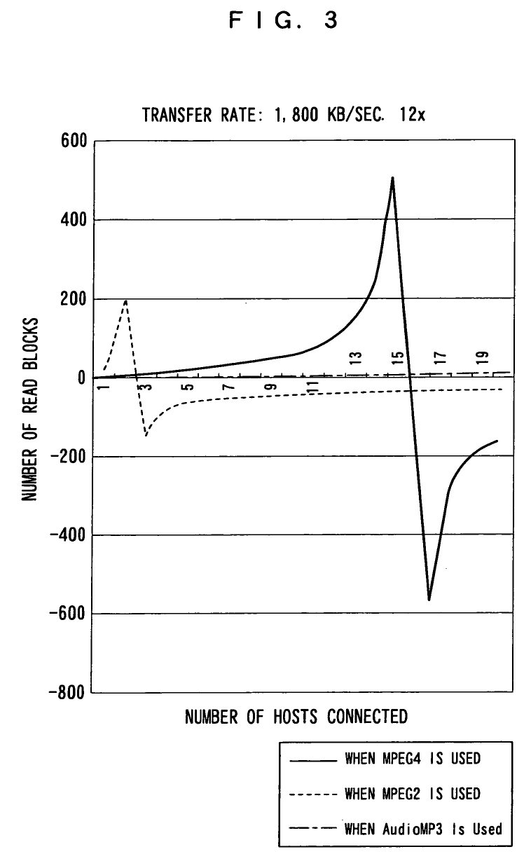

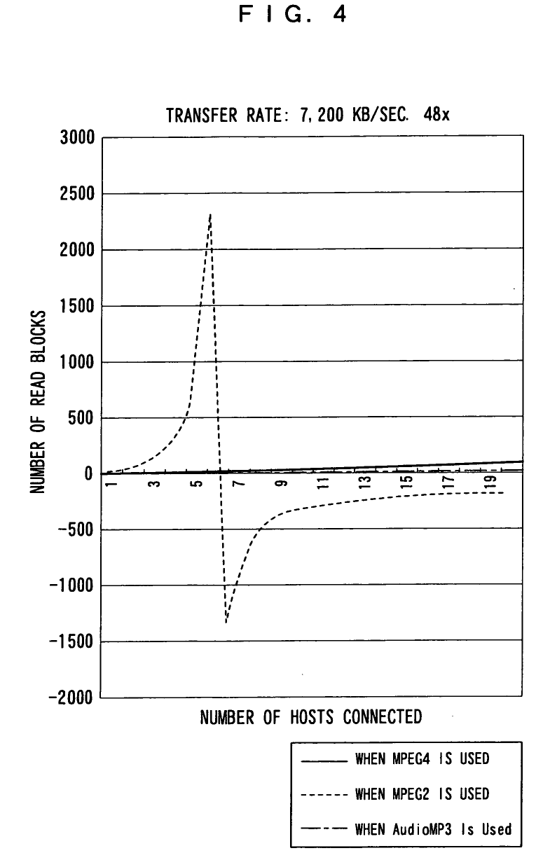

FIG. 2 shows a case where the average data transfer rate of the optical disk device is 900 KB/second (equivalent to 6× speed); FIG. 3 shows a case where the average data transfer rate of the optical disk device is 1,800 KB/second (equivalent to 12× speed); and FIG. 4 shows a case where the average data transfer rate of the optical disk device is 7,200 KB/second (equivalent to 48× speed).

In FIG. 2, for example, the negative numbers of blocks read indicate that data are invalid and cannot be processed. For MPEG4, when the number of hosts connected exceeds 9, the system can no longer process data, indicating the capacity of the system. Similar phenomena are shown in FIGS. 3 and 4.

A data transfer control method according to a second embodiment of the present invention will be described below.

While the firmware in a device, which is an optical disk device, controls data transfer in the transfer control method according to the first embodiment described above, a device driver (driving software) provided in a host computer controls data transfer in the second embodiment.

The second embodiment will be illustrated with respect to an example in which the efficiency of data processing on a host when a request to access the device from that host and an access request from another host are issued concurrently is improved, that is, data is transferred without delay. The environment of the device is the same as that in the first embodiment, therefore like elements are labeled with like reference numerals and the description of which will be omitted.

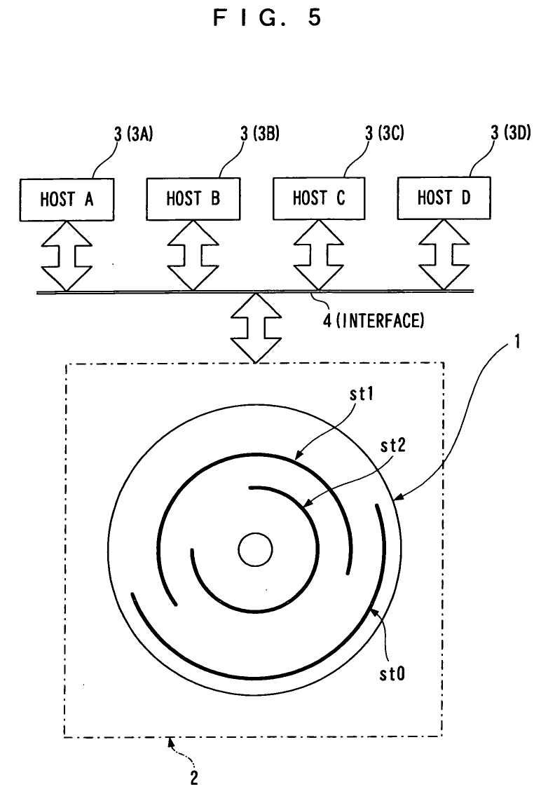

The data transfer control method according to the second embodiment will be described with reference to FIG. 5.

When a task on a host 3 (3A) reproduces stream data, a device driver on the host 3A issues a read command to the device 2. This command is provided with the function of checking the status of connection with the other hosts 3 (3B-3D) connected to the device 2.

When the device 2 receives the command, it checks access requests from the other hosts 3B-3D connected to the device 2 and sends information about the access requests (such as the access positions on the device and the number of data blocks to be read) to the host 3A, in particular to the device driver.

Then, host 3A checks that information about the access requests from the other hosts 3B-3D and determines the number of data blocks that relate to the task on host 3A and are to be transferred beforehand to a data buffer (provided in an interface 4 for example as in the first embodiment) in a manner similar to that described with respect to the first embodiment.

The outline of the process will be described below.

Here, a situation will be described in which requests to access three blocks of stream data st0-st2 on a recording medium 2 are issued. The time required for reading two blocks of stream data st1-st2 other than the first stream data st0 to be read is calculated (the calculation method is the same as that in the first embodiment).

That is, the sum of the time required for seeking from st0 to st1 (ts01+tr01) plus the time required for transferring data to st1 plus the time required for seeking from st1 to st2 (ts12+tr12) plus the time required for transferring data to st2 plus the time required for returning from st2 to st0 (ts20+tr20) is obtained.

Then, an amount of stream data st0 (the number of blocks to be read beforehand) that meets the condition that the time required for transferring stream data st0 be greater than the sum calculated is transferred and stored in the data buffer.

Stream data st0 stored in the data buffer is then transferred to host 3A in a batch during a preparation period for reading the next stream data, st1.

According to this data transfer control method, the device driver provided in the host 3 can be used to obtain same effect as that of the first embodiment. That is, the device driver has the function of implementing the steps described earlier: the step of interpreting an instruction and obtaining the access position of data, the access ordering step of generating an access order table, the data storing step of storing data in the data buffer, and the data transfer step of transferring the data from the data buffer to the host 3.

While the second embodiment has been described with respect to a situation where more than one host requests access to the device at the same time, the method of the second embodiment can also be applied to a situation where more than one task concurrently running on a single host accesses the device.

A data transfer control method according to a third embodiment of the present invention will be described below.

While a single device, which is an optical disk device, is provided in the embodiments described above, the third embodiment enables effective access when a large number of hosts, which are computers, access stream data on recording media in a plurality of devices over a network (an example of an interface).

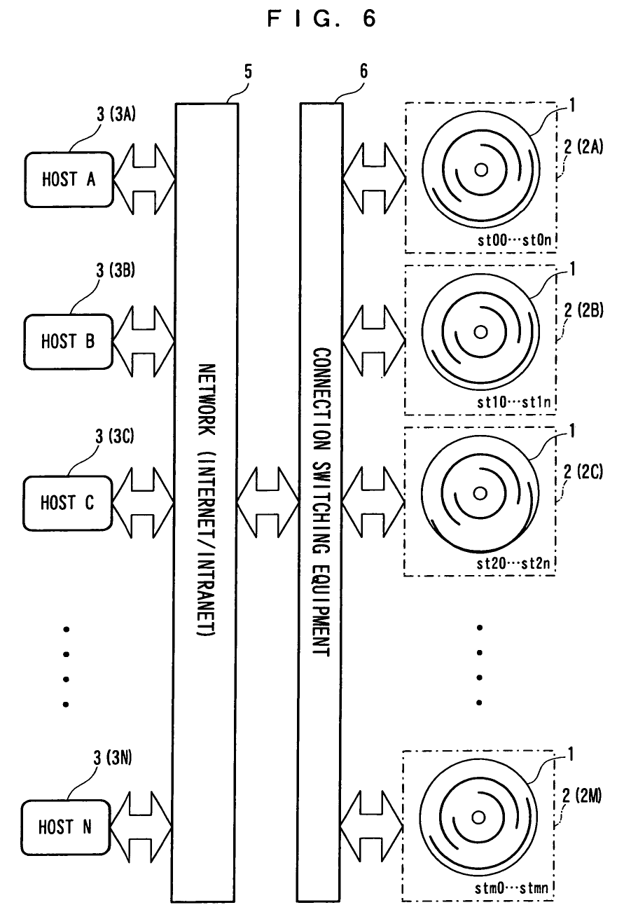

The data transfer control method according to the third embodiment will be described with reference to FIG. 6. The device environment of the third embodiment is much the same as that of the first embodiment. Therefore, like reference numerals are used to denote like elements, which will be described briefly.

In the device environment according to the third embodiment, a plurality of host computers (hereinafter referred to as host A, host B, . . . , host N) 3 (3A, 3B, . . . , 3N) are connected to optical disk devices (hereinafter referred to device A, device B, device N) 2 (2A, 2B, . . . , 2N), each of which is provided with an optical disk (hereinafter referred to a recording medium) 1, through a network (the Internet or an intranet) 5 and connection switching equipment 6, as shown in FIG. 6. The connection switching equipment 6, which is provided on the device side, connects the network 5 with the devices 2 so that the hosts can freely access any of the devices 2. Recorded on the recording media 1 in devices 2 is their respective stream data (st00 . . . st0n, st10 . . . st1n, and st20 . . . st2n, stm0 . . . stmn).

The data transfer control method will be described with respect to an example in which data is transferred between host A and device A.

An access request from host A (3A) is sent through the network 5 and the connection switching equipment 6 to the target device A (2A).

After the access request arrives at device A, an optimum number of blocks of stream data are read from the recording medium 1 in the device A and transferred to a data buffer through the process described with respect to the second and third embodiments.

Then, the stream data is transferred from device A to host A (3A) in a batch over a network through the connection switching equipment 6.

This data transfer process is performed for all devices A (2A) to M (2M). Thus, data can be transferred efficiently and stream data can be distributed over a network by using a smaller number of devices than in the prior art.

1. A data transfer control method for controlling transfer of data from a recording medium in an information recording device to a data processing device having at least a data reproduction function, comprising:
an access position obtaining step of interpreting instructions issued from a plurality of tasks provided on one or more data processing devices (3) to the information recording device (2) and obtaining access positions of data on the recording medium (1);
an access ordering step of generating an access order table for data to be read in sequence, based on the access positions obtained at the access position obtaining step;
a data storing step of reading the data sequentially in accordance with the access order table generated at the access ordering step and storing the data in a data buffer; and
a data transfer step of transferring the data stored in the data buffer to the one or more data processing devices (3) in an operation period before the information recording device (2) becomes ready to transfer the next data.

2. The data transfer control method according to claim 1, wherein, when the information recording device (2) is accessed in response to the instructions from the tasks, firmware provided in the information recording device (2) provides control.

3. The data transfer control method according to claim 1, wherein, when the information recording device (2) is accessed in response to the instructions from the tasks, driving software of the information recording device (2) provided in the one or more data processing devices (3) provides control.

4. The data transfer control method according to claim 1, wherein the amount of data to be stored in the data buffer is determined such that the time required for transferring the data exceeds the total time required for reading by the other tasks than the task to which the data is to be transferred.

5. A data transfer control method for connecting a plurality of data processing devices (3) with a plurality of information recording devices (2) through connection switching equipment (6), and causing the transfer control method according to claim 1 to be performed.
